(19) United States
(12) Patent Application Publication
(10) Pub. No.: US 2006/0222006 A1
(43) Pub. Date: Oct. 5, 2006

(54) Wireline to wireless converter

(76) Inventor: Valery Vinarov, Palatine, IL (US)

Correspondence Address: CARDINAL LAW GROUP, Suite 2000, 1603 Orrington Avenue, Evanston, IL, 60201, US

(21) Appl. No.: 11/397,045

(22) Filed: Apr. 3, 2006

Related U.S. Application Data
(60) Provisional application No. 60/667,812, filed on Apr. 1, 2005.

(51) Int. Cl. H04L 12/56; H04J 3/16

(52) U.S. Cl. 370/466; 370/401

(57) ABSTRACT

A wireline to wireless converter employs a wireless terminal printed circuit board serving as a wireless interface to a wireless network, and a wireless to wireline protocol converter serving as a wireline interface to a wireline infrastructure. In operation, the wireless to wireline protocol converter converts wireless signals received by the wireless terminal printed circuit board from the wireless network into wireline signals in accordance with a wireline protocol associated with the wireline infrastructure, and converts wireline signals received from the wireline infrastructure into wireline signals in accordance with a wireless protocol associated with the wireless network.

### RELATED APPLICATION DATA

This application claims the benefit of U.S. Provisional Application Ser. No. 60/667,812 filed on Apr. 1, 2005. The entirety of the application is hereby incorporated by reference.

### TECHNICAL FIELD OF THE INVENTION

This invention relates to systems, methods and devices for providing wireline to wireless conversion.

### BACKGROUND OF THE INVENTION

FIG. 1 illustrates a wireline network 10 including a local exchange network 20, a PSTN core network 30, enterprise premises 40 and subscribers 50. Local exchange network 20 is in wireline communication with PSTN core network 30, enterprise premises 40 and subscribers 50. PSTN core network 30 includes interoffice trunks 32, subscriber lines 34 and local central service 36.

What is needed is an enabling connectivity and reuse of existing household and commercial enterprise wireline network 10 to a wireless network.

### SUMMARY OF THE INVENTION

A first form of the present invention is a wireline to wireless converter employing a wireless terminal printed circuit board serving as a wireless interface to a wireless network, and a wireless to wireline protocol converter serving as a wireline interface to a wireline infrastructure. In operation, the wireless to wireline protocol converter converts wireless signals received by the wireless terminal printed circuit board from the wireless network into wireline signals in accordance with a wireline protocol associated with the wireline infrastructure, and converts wireline signals received from the wireline infrastructure into wireline signals in accordance with a wireless protocol associated with the wireless network.

The aforementioned form and other forms as well as objects and advantages of the present invention will become further apparent from the following detailed description of various embodiments of the present invention read in conjunction with the accompanying drawings. The detailed description and drawings of the various embodiments of the present invention are merely illustrative of the present invention rather than limiting, the scope of the present invention being defined by the appended claims and equivalents thereof.

### DESCRIPTION OF THE DRAWINGS

FIG. 1 illustrates a wireline network as known in the art;

FIG. 2 illustrates a wireless network in accordance with the present invention;

FIG. 3 illustrates one embodiment of a wireline to wireless converter in accordance with the present invention;

FIG. 4 illustrates exemplary housing configurations of a wireline to wireless converter in accordance with the present invention; and

FIG. 5 illustrates an exemplary manufacturing configuration of a wireline to wireless converter in accordance with the present invention.

### DETAILED EMBODIMENTS OF THE INVENTION

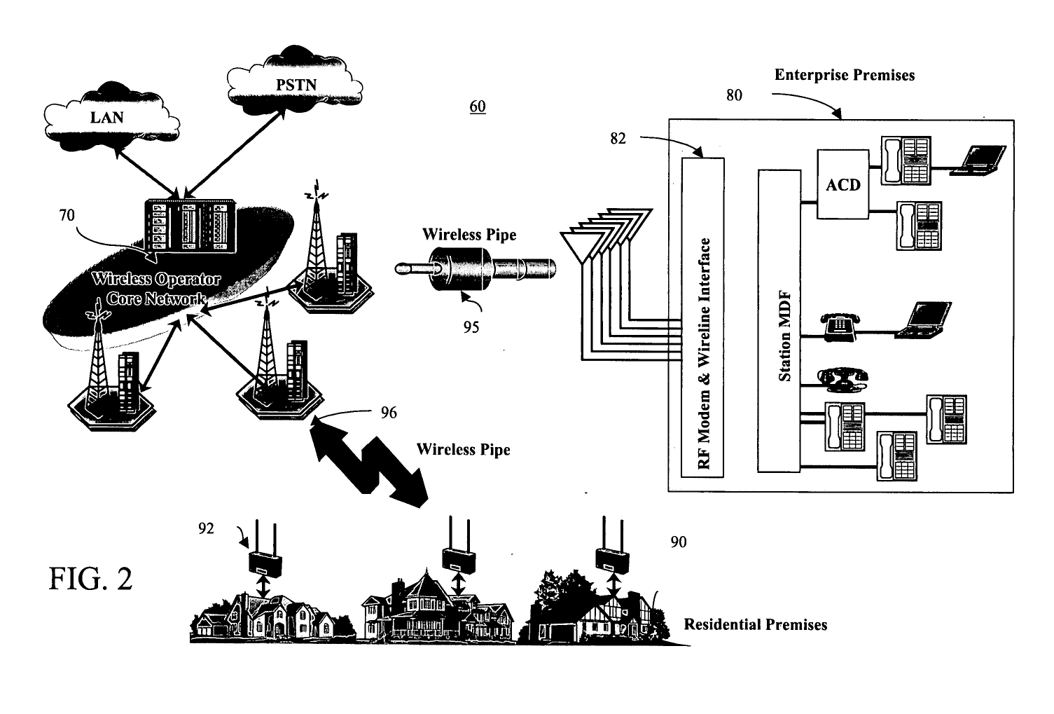

FIG. 2 illustrates a wireless network 60 including a wireless operator core network 70, enterprise premises 80 and residential premises 90. Wireless operator core network is connected to enterprise premises 80 via wireless pipe 95 and residential premises 90 via wireless pipe 96. Enterprise premises 80 includes RF modem and wireline interface 82. Residential premises 90 includes converter 92 for converting wireless to wireline.

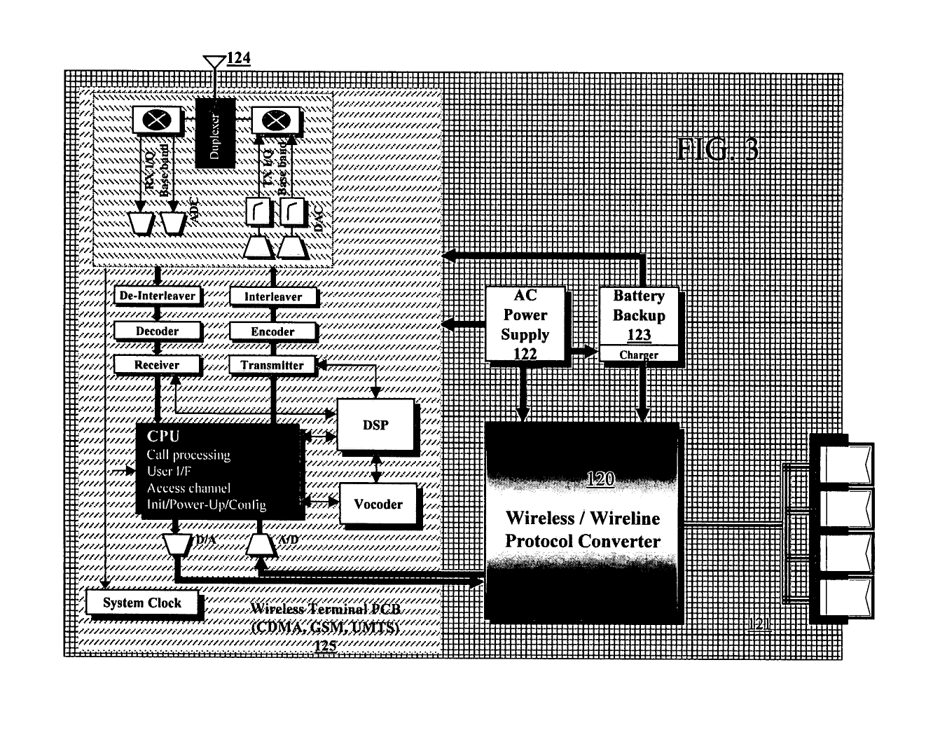

The wireline to wireless converter enables connectivity and reuse of existing household and commercial enterprise wireline (phone lines) infrastructure to wireless network. The wireline to wireless conversion system includes hardware and software capable of converting, for example, residential wireline interfaces to wireless interfaces via a wireless/wireline protocol converter 120 shown in FIG. 3.

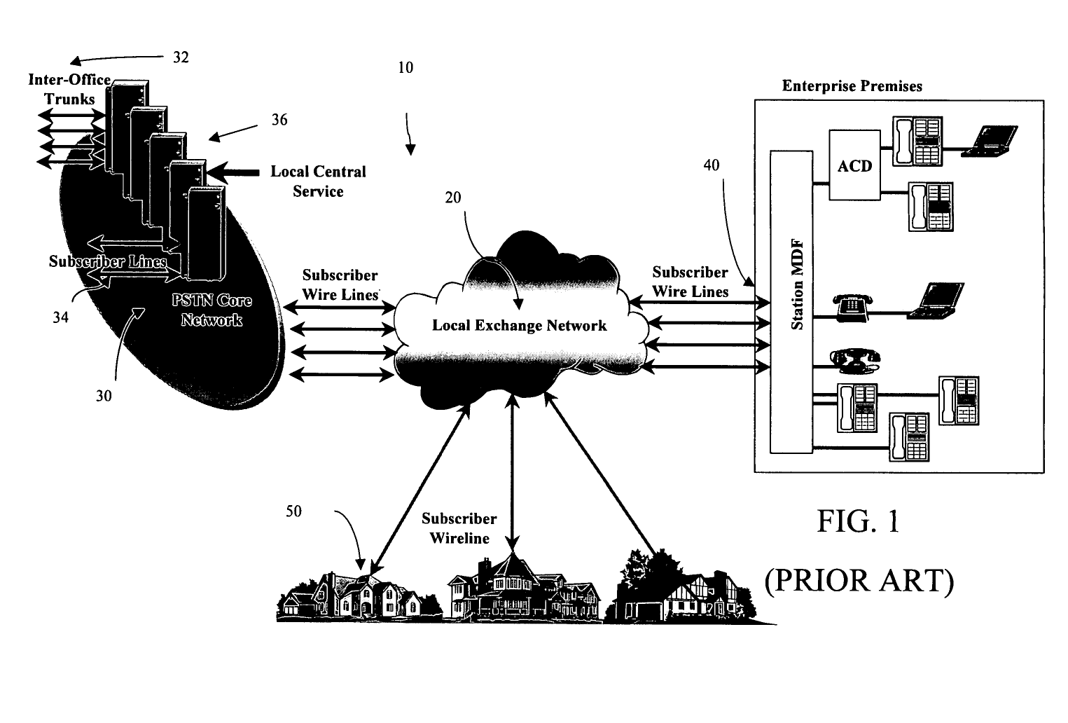

Specifically, a wireless terminal printed circuit board 125 receives wireless signals from a wireless network (e.g., wireless network 60 shown in FIG. 2) via an antenna 124 whereby wireless to wireline protocol converter 120 is designed in accordance with a wireline protocol to convert wireless signals in analog form into wireline signals to be communicated to a wireline infrastructure (e.g., wireline infrastructure 10 shown in FIG. 1) via a set of wireline jacks 121.

Similarly, a wireless to wireline protocol converter 120 receives wireline signals from a wireline infrastructure (e.g., wireline infrastructure 10 shown in FIG. 1) via a set of wireline jacks 121 whereby wireless to wireline protocol converter 120 is designed in accordance with a wireless protocol to convert wireline signals into wireline signals of analog form to be communicated to a wireless terminal printed circuit board 125 for transmission to a wireless network (e.g., wireless network 60 shown in FIG. 2) via antenna 124.

Both converter 120 and PCB 124 are powered by an AC power supply 122 and a battery backup 123. PCB 124 further includes a digital-to-analog converter for converting wireless signals to be communicated to converter 120 from digital form to analog form, and an analog-to-digital converter for converting wireless signals received from converter 120 from analog form to digital form.

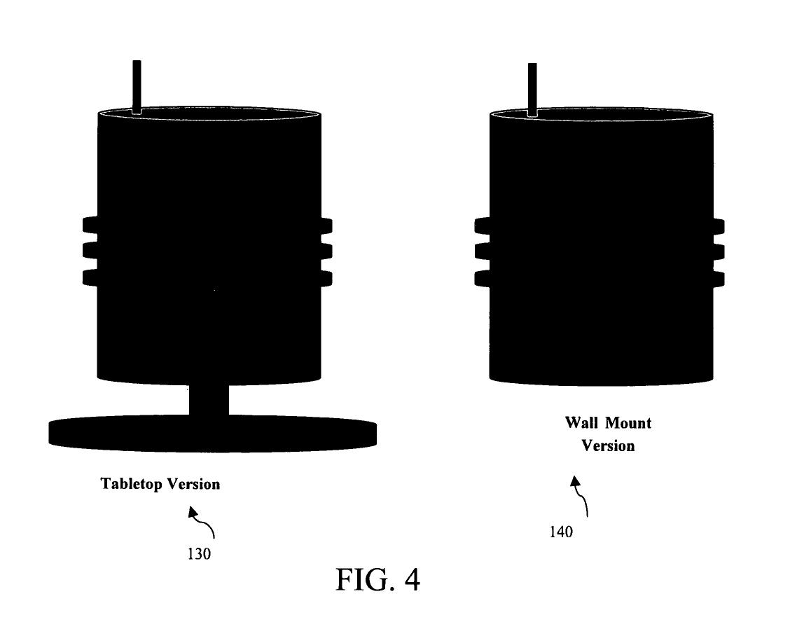

FIG. 4 illustrates residential applications of the wireline to wireless converter having either a tabletop configuration 130 or a wall mount configuration 140.

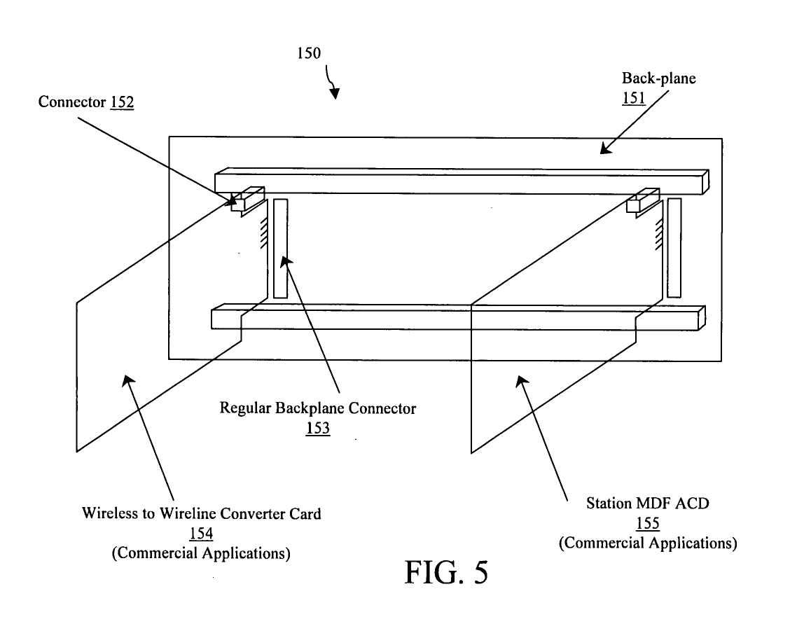

FIG. 5 illustrates a commercial application 150 of the wireline to wireless converter. In this application, a wireless to wireline converter card 154 and a station MDF ACD are operably connected to a backplane 151 via connectors 152 and 153.

I claim:

1. A wireline to wireless converter, comprising:
a wireless terminal printed circuit board serving as a wireless interface to a wireless network; and
a wireless to wireline protocol converter serving as a wireline interface to a wireline infrastructure,
wherein the wireless to wireline protocol converter is operable to convert a first set of wireless signals received by the wireless terminal printed circuit board from the wireless network into a first set of wireline signals in accordance with a wireline protocol associated with the wireline infrastructure, and
wherein the wireless to wireline protocol converter is further operable to convert a second set of wireline signals received from the wireline infrastructure into a second set of wireline signals in accordance with a wireless protocol associated with the wireless network.

2. The wireline to wireless converter of claim 1, wherein the wireless to wireline protocol converter is structured as a card programmed to implement the wireline protocol conversion and the wireless protocol conversion.

3. The wireline to wireless converter of claim 1, wherein the card is connected to a backplane.

4. The wireline to wireless converter of claim 1, wherein the wireless to wireline protocol converter is operably connected to a set of wireline jacks.

5. The wireline to wireless converter of claim 1, further comprising an antenna operably connected to the wireless terminal printed circuit board.

6. The wireline to wireless converter of claim 1, wherein the wireless terminal printed circuit board converts the first set of wireless signals from digital form to analog form prior to communicating the first set of wireless signals to the wireless to wireline protocol converter.

7. The wireline to wireless converter of claim 1, wherein the wireless terminal printed circuit board converts the second set of wireless signals from analog form to digital form upon receiving a communication of the second set of wireless signals from the wireless to wireline protocol converter.

8. The wireline to wireless converter of claim 1, wherein the wireline to wireless converter is in a tabletop configuration.

9. The wireline to wireless converter of claim 1, wherein the wireline to wireless converter is in a wall mount configuration.

10. A wireline to wireless converter, comprising:
a wireless terminal printed circuit board serving as a wireless interface to a wireless network; and
a wireless to wireline protocol converter serving as a wireline interface to a wireline infrastructure, wherein the wireless to wireline protocol converter includes
means for converting a first set of wireless signals received by the wireless terminal printed circuit board from the wireless network into a first set of wireline signals in accordance with a wireline protocol associated with the wireline infrastructure, and
means for converting a second set of wireline signals received from the wireline infrastructure into a second set of wireline signals in accordance with a wireless protocol associated with the wireless network.

11. A method of wireline to wireless conversion, the method comprising:
employing a wireless terminal printed circuit board serving as a wireless interface to a wireless network; and
employing a wireless to wireline protocol converter serving as a wireline interface to a wireline infrastructure,
operating the wireless to wireline protocol converter to convert a first set of wireless signals received by the wireless terminal printed circuit board from the wireless network into a first set of wireline signals in accordance with a wireline protocol associated with the wireline infrastructure; and
operating the wireless to wireline protocol converter to convert a second set of wireline signals received from the wireline infrastructure into a second set of wireline signals in accordance with a wireless protocol associated with the wireless network.
